(19) United States
(12) Patent Application Publication
(10) Pub. No.: US 2016/0189553 A1
(43) Pub. Date: Jun. 30, 2016

(54) Cognitive Educational Tool For Effectuating Learning

(71) Applicant: Christopher Kayode Giwa, Toledo, OH (US)

(72) Inventor: Christopher Kayode Giwa, Toledo, OH (US)

(21) Appl. No.: 14/971,398

(22) Filed: Dec. 16, 2015

Related U.S. Application Data
(62) Division of application No. 12/072,873, filed on Feb. 29, 2008, now abandoned.
(60) Provisional application No. 60/892,769, filed on Mar. 2, 2007.

(51) Int. Cl. G09B 3/00; G09B 19/00

(52) U.S. Cl. CPC G09B 3/00; G09B 19/00

(57) ABSTRACT

The following concept is to be utilized in the acquisition of information by combining various learning styles. Key areas addressed are the increment of student participation, increased levels of student honesty, and higher rates of student responsivity. The tool encourages the development of student-teacher rapport levels and thus promotes the ability to acquire and retain functional techniques and information. The concept addresses real life situations by creating functional problem solving strategies to be used at specific junctures in both the scenarios and everyday life. The tool is preventative in nature, and is also culturally, cognitively, age appropriate, gender and scenario flexible. The adaptability highlights the vast spectrum of issues the concept can resolve. Overall the process is designed to increase participants' level of competency when encountering situations, which impact their pro social development and/or success in real life situations.

### CROSS-REFERENCE TO RELATED APPLICATIONS

This application is a divisional patent application of U.S. patent application Ser. No. 12/072,873, filed Feb. 29, 2008, which claims the benefit of U.S. Provisional Application No. 60/892,769, filed Mar. 2, 2007. The disclosures of both applications are incorporated herein by reference.

### BACKGROUND OF THE INVENTION

The present invention relates to educational games, and more specifically pertains to a new educational conceptual framework model for identifying negative outcomes in any given decision making process. The said educational conceptual framework model can be used in areas such as, but not limited to scenario setting, teaching, counseling, training and so on.

In education, various advantages of using private teachers to give individual attention to accommodate each student's skill, educational goals and background are well known. Students can excel and improve immensely tests/assessments of the student's skill, educational goals and background in designing individualized curriculum make the private teacher approach too expensive for most students.

Many conventional educational systems attempt to personalize learning sessions for students and avoid the cost of employing private tutors by using computer programs in place of actual teachers. However, these systems have gone too far in automating educational processes and consequently have been shown to be too automated and lacking the necessary involvement by actual teachers to make the systems effective.

Many school systems have become highly centralized. Large schools have evolved, which serve wide geographic areas. The geographic area covered by some schools is so wide that certain students must make a round trip of one hundred miles, or more, to attend classes. One benefit of a large, centralized school is that a vast, diverse curriculum can be offered. It is desirable to offer the diverse curriculum, without imposing the long-distance.

People tend to differ widely in how they best receive and process information. For example, if a group of people are learning about ceramics in a classroom setting, one individual may best understand and process the information by listening to the instructor lecture. Another student may prefer to read the textbook, while still another may understand and retain the most information when they see photographs or diagrams illustrating the concepts. Others still may prefer an early morning class to an afternoon or evening class, or prefer studying in a large comfortable chair in a brightly lit room while listening to classical music.

The extent to which an individual receives sensory information in a format and setting that is compatible with how they best process information goes a long way towards determining how well that person learns. Formats and settings that deviate somewhat from a person's ideal can degrade that person's ability to learn. Formats and/or settings that deviate significantly from a person's ideal can actually prevent the person from learning. This situation can be seen in many schools where some children fail to learn, not because they do not have the intelligence to understand and process the lessons, but because the instruction is presented in a format and/or setting that deviates significantly from the particular child's ideal.

A considerable amount of research has been devoted to identifying a person's “learning style”, i.e., the various formats, environmental settings and other variables that are most compatible with how that person best understands and processes sensory information. So-called “learning style models” have been developed in which specific and varied information is gathered from an individual and used to extrapolate that person's learning style. The information may be gathered through direct observation of the person, paper and pen questionnaires, pencil-based answer sheets of the type that can be scanned into a computer scoring system, or computer assisted questionnaires in which the user answers the various test questions as they are presented on the computer screen. The questionnaires generally include a range of possible answers such as always, usually, sometimes, rarely and never.

The questionnaire answers are then analyzed, either manually or by computer, to produce a learning style profile. The learning style profile is then analyzed, again either manually or by computer, to produce a learning style report. Under the manual analysis technique, an individual specifically trained in the particular learning style model must interpret the profile in order to generate a report. Under a computer analysis technique, the profile data must be re-entered in order to produce the report. In either case, the learning style report identifies individual learning factors and may include suggestions for learning enhancements.

The above-described learning style model questionnaires can be extremely tedious for the person taking the test. In particular, they are typically lengthy and require good silent reading and comprehension skills and a long attention span in order to render relevant information. The options for administering any given questionnaire, or for analyzing questionnaire results, are generally limited and not very flexible. Accordingly, there is a need for a more flexible and user-friendly method of administering learning style model questionnaires and analyzing the results thereof.

it is widely acknowledged that education is truly a key to many facets of life. In fact, education is and historically has been, in the United States and many countries, a leading public policy priority. Therefore, improvements in the ability to provide learning, from the standpoint of meaningful success for the students, as well as efficient allocation of resources towards that end, should be a primary goal of all levels of government and its citizens. Studies have shown that one root of illiteracy is lack of foundational learning and training by the first grade level. A need therefore exists regarding efficient and effective training of pre-reading skills for first graders and even kindergartners. The ability of children this age to self-teach is minimal. Therefore, an effective automated learning assistance system would be of tremendous value to children, as well as society in general, if viewed from a long-term perspective.

### SUMMARY OF THE INVENTION

An educational conceptual framework in the form of a game, which incorporates movement or interaction for the participants as a key part of the learning process through two phases.

The said learning process involves a given ‘scenario card’ which describes a situation from any venue of life. The participants read the initial ‘scenario card’ and on a turn basis select a ‘movement card’ which help said participants move from ‘station card’ to ‘station card’. This is known as phase one of the exercise. Each ‘station card’ has a number of ‘movement cards’ directing the movement of said participants. Each participant retains every ‘movement card’ selected. In phase two there are ‘critical thinking cards’ which correspond specifically to a particular ‘movement card’ utilized in phase one.

The instructor/teacher/counselor/generates analytical discussion of decisions made with the aid of the ‘critical thinking cards’, again completed on a turn basis with each participant. When this is completed the exercise is finished.

The said educational conceptual framework as described is in the form of laminated cards; said ‘station cards’ measure 9″×12″, said ‘movement cards’ and said ‘critical thinking cards’ measure 3″×4″. The level of movement is the key attribute, particularly with younger participants. The use of props by the said ‘station cards’ is essential since it aids the user by way of a visual reminder.

The level of language used to describe said ‘scenario cards’, ‘movement cards’, and ‘critical thinking cards’ can vary depending on the targeted participants.

The said educational conceptual framework can be used in other formats, such as but not limited to computer software, video and DVD, and other optical disc storage technology. Utilizing these formats allows for interactive learning. The software will also provide the ability to capture the forward and backward movement detailed in the laminated card version.

The laminated card version of said educational conceptual framework will have various props at the said ‘station cards’. The purpose is to increase the level of visual stimulation particularly in scenarios designed for younger participants. The use of visual aids will increase the level of ability to recollect information of said participants, especially when engaged in real life situations.

Generally the said educational conceptual framework model is an invention with the premise of overcoming and surpassing the shortcomings of existing educational games. Most importantly the introduction of movement and the incorporation of visual aids will significantly increase the user's ability to retain information. With the increased information retention, the said educational conceptual framework model is preventive in nature in that it will allow participants to avoid harmful outcomes in real life scenarios with repeated practices of said material. Utilization of the said practice will increase the users' comprehension of any given situation in areas such as, but not limited to everyday life, workplace, school and so on.

It will be appreciated that the scope of the present invention is not limited to the above-described embodiments but rather is defined by the appended claims, and that these claims will encompass modifications of and improvements to what has been described.

The description of the invention which follows, together with the accompanying figures should definitely not be construed as limiting the concept to the example shown and described. The scope of the said educational conceptual framework is infinite, and countless scenarios will be devised within the ambit of the appended claims.

### BRIEF DESCRIPTION OF THE DRAWINGS

FIG. 1 illustrates a plurality of cards that comprise an educational conceptual framework in accordance with this invention.

FIG. 2 illustrates one of the start cards shown in FIG. 1.

FIG. 3 illustrates one of the movement cards shown in FIG. 1.

FIG. 4 illustrates another one of the movement cards shown in FIG. 1.

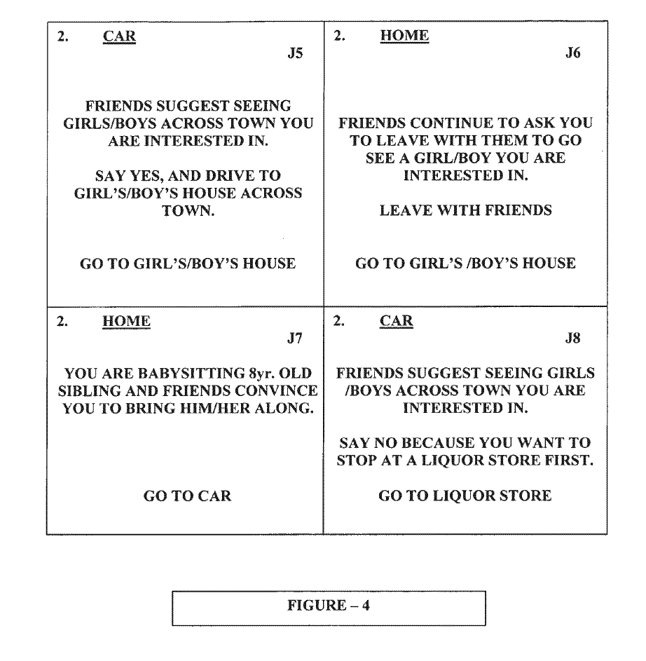

FIG. 5 illustrates another one of the movement cards shown in FIG. 1.

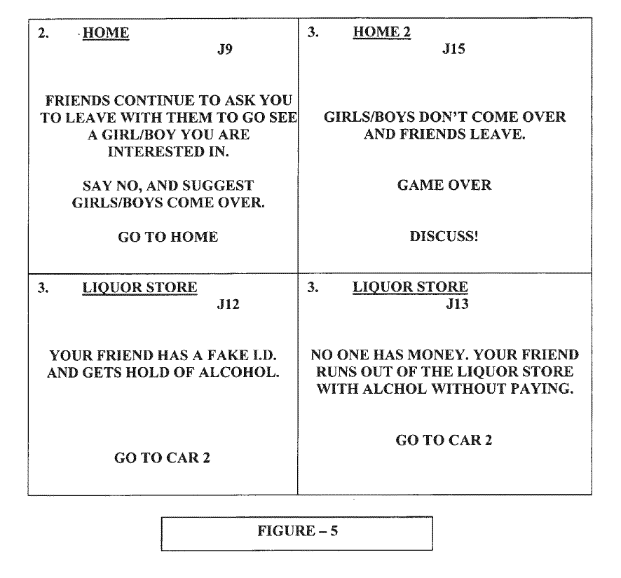

FIG. 6 illustrates another one of the movement cards shown in FIG. 1.

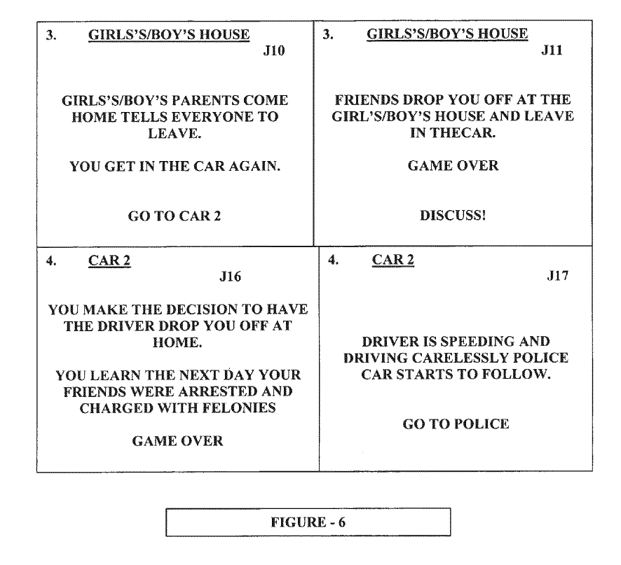

FIG. 7 illustrates another one of the movement cards shown in FIG. 1.

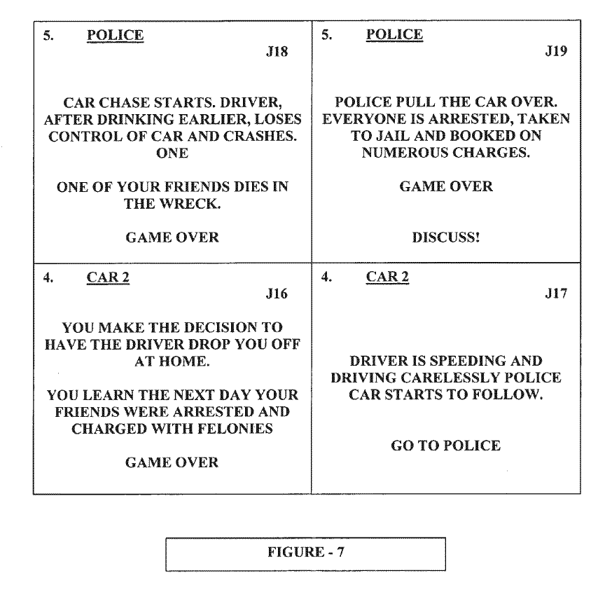

FIG. 8 illustrates another one of the cards shown in FIG. 1.

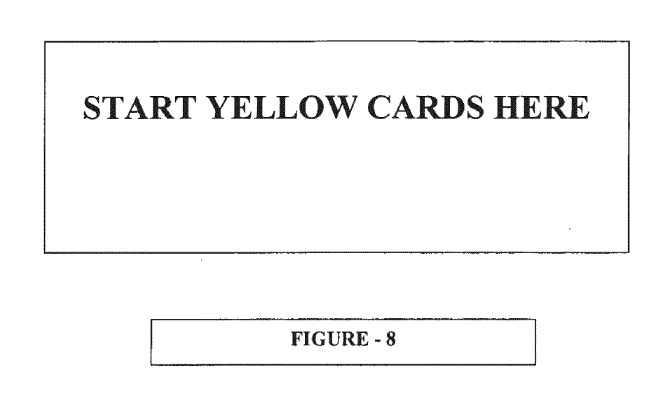

FIG. 9 illustrates one of the critical thinking cards shown in FIG. 1.

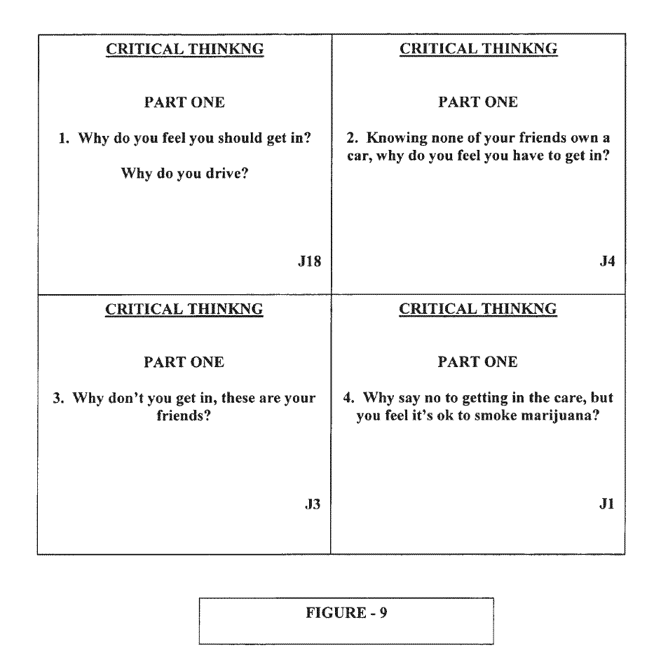

FIG. 10 illustrates another one of the critical thinking cards shown in FIG. 1.

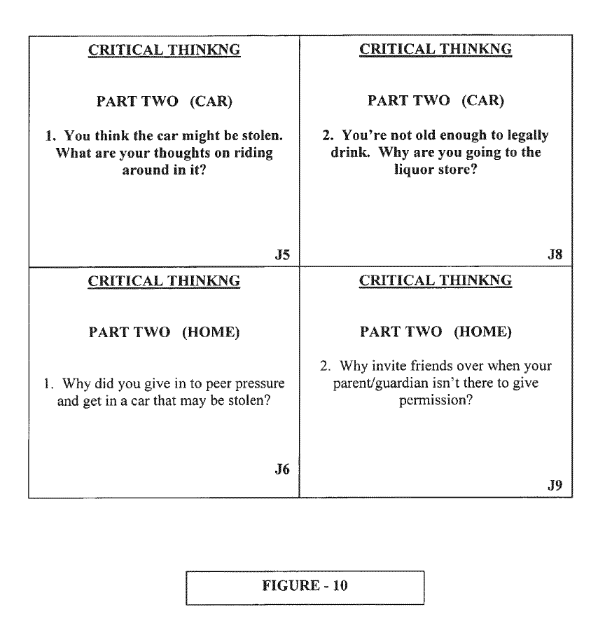

FIG. 11 illustrates another one of the critical thinking cards shown in FIG. 1.

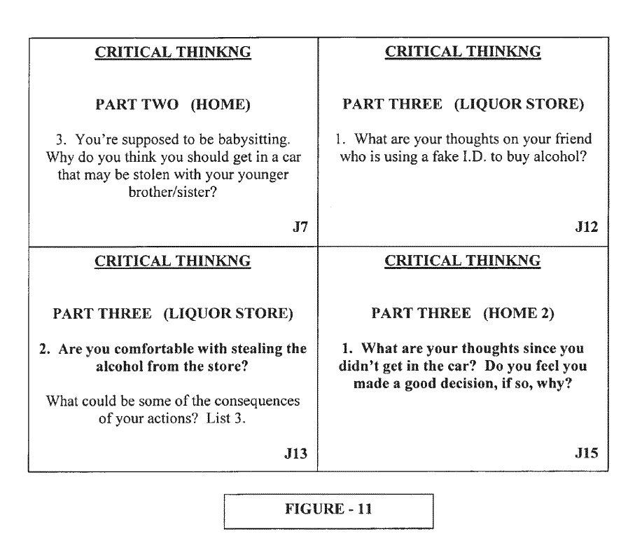

FIG. 12 illustrates another one of the critical thinking cards shown in FIG. 1.

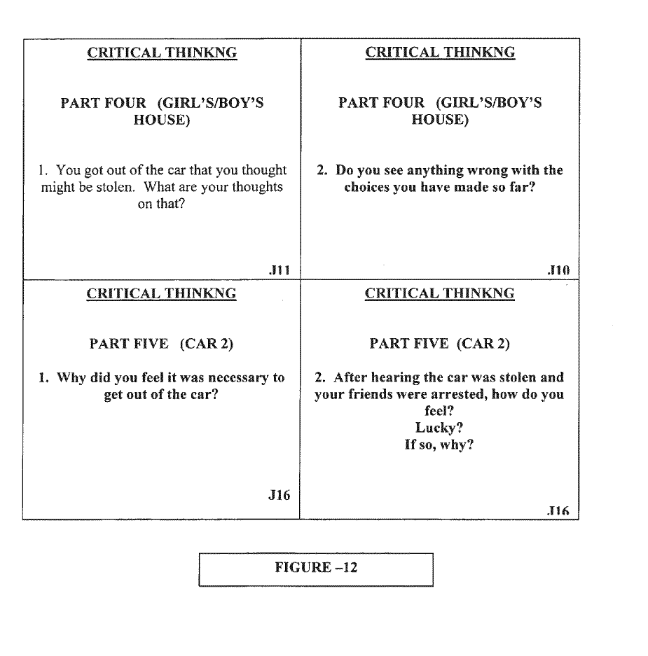

FIG. 13 illustrates another one of the critical thinking cards shown in FIG. 1.

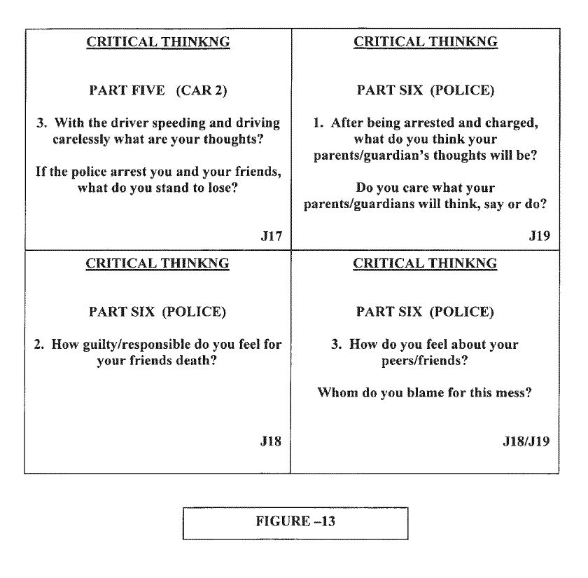

### DETAILED DESCRIPTION OF THE PREFERRED EMBODIMENT

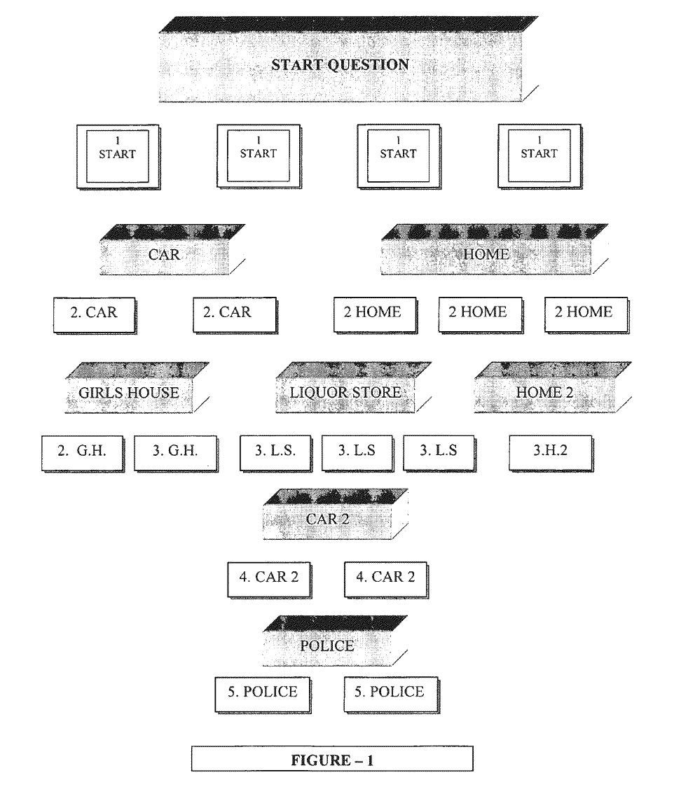

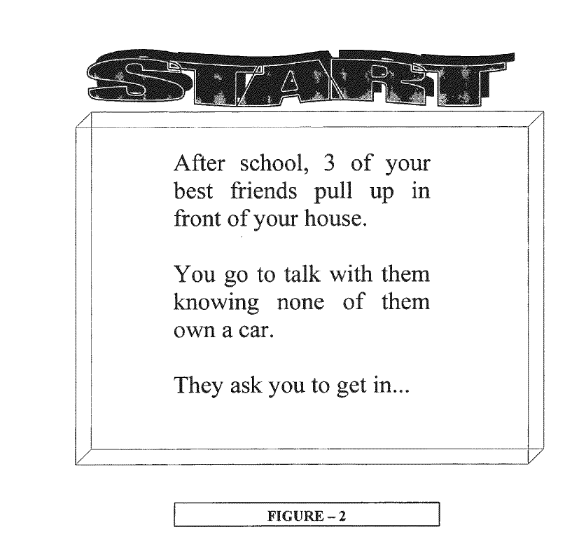

With reference now to the illustrations, and specifically FIG. 1 to FIG. 3 thereof, a new educational conceptual framework for learning and practicing steps in any given decision making process, thus highlighting possible problem areas will now be described.

FIG. 1 provides a front elevational view of how the concept is set up. The cards are all placed on the floor in a room that will allow for maximum movement, i.e., a classroom/training room. In this particular example, there are 8 ‘station cards’—labeled ‘A’ through ‘H’. There are also 19 ‘movement cards’—labeled ‘J1’ through ‘J19’.

In FIG. 1, (A) represents the starting point of the scenario and the particular topic being taught/practiced. On card 1(A) is a given situation, which either the instructor(s) or participants read out aloud. Below the Start ‘station card’ are four ‘movement cards’—labeled ‘J1’ through ‘J4’, (note all the ‘movement cards’ are placed on the floor face down, the reason being participants believe selecting ‘movement cards’ at random injects an element of choice into the game). On a turn basis the participants select 1 ‘movement card’. Each participant reads the information on the card aloud, and before moving onto the next ‘station card’ retains the selected ‘movement card’ on their person. The ‘movement cards’ should be kept in the order they were selected. ‘Movement cards’ ‘J1’ through J4’ contains a specific ‘decision’ which the participant has to follow. At the bottom right-hand corners of the ‘movement cards’ are instructions, which direct the participants to the next ‘station card’.

Participants progress through the exercise selecting ‘movement cards’ and moving from ‘station card’ to ‘station card’. The level of writing on the ‘movement cards’ can vary depending on the grade level/age/comprehension of the participants. The movement from ‘station card’ to ‘station card’ can vary depending on the participant's age group. For example younger children can jump, hop, or skip from ‘station card’ to ‘station card’, hence the need for a large room. The purpose behind such a technique is to infuse enjoyment into the learning process, and to distance participants from the traditional textbook learning process. In doing this the ability to retain newly acquired information is greatly increased.

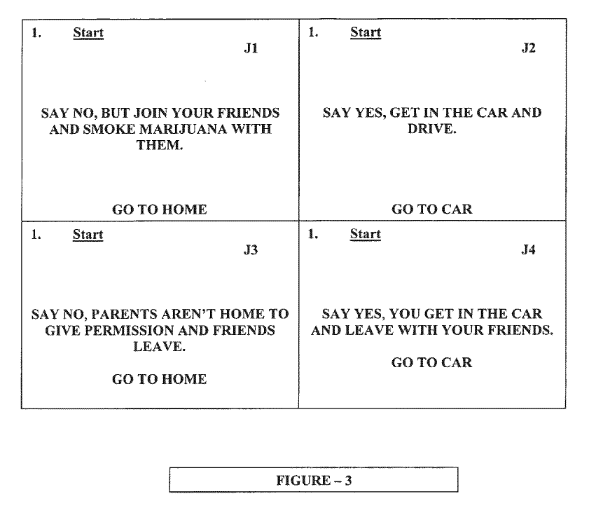

Participants proceed through the given scenario by way of the ‘movement cards’. Phase one of the exercises is completed when the ‘movement cards’ indicate so. When the first phase of the exercise has been completed Phase two, begins. Phase two is depicted in FIG. 3 with the use of the ‘critical thinking cards’. The premise of Phase two is to elicit discussion through the analysis of the ‘decisions’ each participant has made. Remembering both participants have retained the ‘movement cards’ from Phase one of the exercise is essential to Phase two. The instructor/counselor utilizes the ‘critical thinking cards’ to generate analytical discussion about the scenario in question. Each ‘movement card’ that the participants retain has a corresponding ‘critical thinking card’ the instructor uses the ‘critical thinking card’, (that corresponds to said ‘movement card’), to ascertain as to why a certain ‘decision’ was made. In turn the participant is expected to explain why they ‘made’ a certain decision in the scenario. This practice encourages the participants to place themselves in the scenario and analytically think of responses. The cognitive process that occurs will allow for a person to not only create ‘forced responses’ but also shows how they will think, should they ever face the scenario in a real life situation. The instructor analyzes each participants ‘movement card’ on a turn basis.

Upon review this educational conceptual framework has a unique approach to the learning/practicing of infinite scenarios. As opposed to textbook learning, the said educational conceptual framework allows for a multi-systemic approach to retaining information. Phase one of the exercise draws in the participants by the use of movement, tactile, and visual techniques. Abstract thought and the ability to analyze ‘poor decisions’ ahead of time allows for the safe immersion in negative and positive human experiences, and illustrates how poor choices can escalate into tragic outcomes. Repeated practices of any given scenario in the educational conceptual framework will undoubtedly increase the participants' ability to avoid pitfalls in real life situations. The advantages and scope of the said educational conceptual framework herein are not to be limited to, or defined by the example listed. The example can be applied to an inordinate amount of scenarios, involving numerous participants. The version denoted in the example of the educational conceptual framework can be presented to users in a variety of other formats, including, but not limited to interactive computer software, interactive video, interactive DVD, and so on.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A cognitive educational tool for effectuating learning comprising:
a scenario card describing a situation from a venue of life;
a plurality of movement cards associated with the scenario card, each of the plurality of movement cards including both: (1) a decision that is related to the scenario card; and (2) either (a) a direction to another one of the plurality of movement cards or (b) an ending instruction; and
a critical thinking card associated with each of the plurality of movement cards, each of the critical thinking cards including a question for generating an analytical discussion about the situation from the venue of life described in the scenario card.

2. A method for effectuating learning comprising the steps of:
providing a scenario card describing a situation from a venue of life;
providing a plurality of movement cards associated with the scenario card, each of the plurality of movement cards including both: (1) a decision that is related to the scenario card; and (2) either (a) a direction to another one of the plurality of movement cards or (b) an ending instruction; and
providing a critical thinking card associated with each of the plurality of movement cards, each of the critical thinking cards including a question for generating an analytical discussion about the situation from the venue of life described in the scenario card.
